(19) United States
(12) Patent Application Publication
(10) Pub. No.: US 2024/0410848 A1
(43) Pub. Date: Dec. 12, 2024

(54) FLUID COMPOSITION SENSOR

(71) Applicant: Cypress Semiconductor Corporation, San Jose, CA (US)

(72) Inventors: Volodymyr BIHDAY, Lviv (UA); Yaroslav BERKO, Zhovkva (UA); Igor KRAVETS, Lviv (UA); Mykhaylo KREKHOVETSKYY, Lviv (UA); VasyI MANDZIY, Lviv (UA); Marian MULIARCHYK, Maheriv (UA); Andrii Tsemko, Melitopol (UA)

(73) Assignee: Cypress Semiconductor Corporation, San Jose, CA (US)

(21) Appl. No.: 18/329,907

(22) Filed: Jun. 6, 2023

(51) Int. Cl. G01N 27/04; G01N 27/06

(52) U.S. Cl. CPC G01N 27/045; G01N 27/06

(57) ABSTRACT

One or more computing devices, systems, and/or methods are provided. In an example, a method comprises measuring a first charge generated by a first excitation signal and transferred during a first time interval to a first electrode mounted to a container holding a test fluid, measuring a second charge generated by a second excitation signal and transferred during a second time interval to the first electrode, and determining a parameter of the test fluid based on a first charge transfer curve generated based on the first charge and the second charge.

### BACKGROUND

Various sensing techniques may be used for sensing a level or a characteristic of a fluid in a container. There is a growing market for combined fluid level and fluid characterization in automotive, Internet of Things (IoT), and consumer spaces. For example, some applications for fluid level and fluid property sensing can include systems for windshield washing fluid, fuel, water hardness level for coffee machines, smart sensing in refrigerators, and/or the like. Many of these applications require non-contact sensing where there is no electrical contact between the sensor and the fluid.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In an embodiment of the techniques presented herein, a method comprises measuring a first charge generated by a first excitation signal and transferred during a first time interval to a first electrode mounted to a container holding a test fluid, measuring a second charge generated by a second excitation signal and transferred during a second time interval to the first electrode, and determining a parameter of the test fluid based on a first charge transfer curve generated based on the first charge and the second charge.

In an embodiment of the techniques presented herein, a system comprises means for measuring a first charge generated by a first excitation signal and transferred during a first time interval to a first electrode mounted to a container holding a test fluid, means for measuring a second charge generated by a second excitation signal and transferred during a second time interval to the first electrode, and means for determining a parameter of the test fluid based on a first charge transfer curve generated based on the first charge and the second charge.

In an embodiment of the techniques presented herein, a system comprises a container, a first electrode mounted to the container, a signal generator configured to apply a first excitation signal to the first electrode during a first time interval and to apply a second excitation signal to the first electrode during a second time interval, a first device configured to measure a first charge generated by the first excitation signal and transferred during the first time interval to the first electrode and to measure a second charge generated by the second excitation signal and transferred during the second time interval to the first electrode, and a processor configured to determine a parameter of a test fluid in the container based on a first charge transfer curve generated based on the first charge and the second charge.

In an embodiment of the techniques presented herein, a non-transitory computer-readable medium stores instructions that when executed facilitate performance of operations comprising receiving a first charge generated by a first excitation signal and transferred during a first time interval to a first electrode mounted to a container holding a test fluid, receiving a second charge generated by a second excitation signal and transferred during a second time interval to the first electrode, and determining a parameter of the test fluid based on a charge transfer curve generated based on the first charge and the second charge.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a diagram illustrating an example system for fluid characterization, in accordance with some embodiments.

FIG. 2 is a diagram of an equivalent circuit for a container sensing arrangement, in accordance with some embodiments.

FIG. 3 is a diagram of a charge transfer curve, in accordance with some embodiments.

FIG. 4 is a diagram of a neural network for fluid characterization, in accordance with some embodiments.

FIG. 5 is a diagram of a processing unit, in accordance with some embodiments.

FIG. 6 is a diagram illustrating a method for characterizing a fluid, in accordance with some embodiments.

FIG. 7 illustrates an exemplary embodiment of a computer-readable medium, in accordance with some embodiments.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

It is to be understood that the following description of embodiments is not to be taken in a limiting sense. The scope of the present disclosure is not intended to be limited by the embodiments described hereinafter or by the drawings, which are taken to be illustrative only. The drawings are to be regarded as being schematic representations and elements illustrated in the drawings are not necessarily shown to scale. Rather, the various elements are represented such that their function and general purpose become apparent to a person skilled in the art.

All numerical values within the detailed description and the claims herein are modified by “about” or “approximately” the indicated value, and take into account experimental error and variations that would be expected by a person having ordinary skill in the art.

Fluid characterization finds applications in auto, consumer, and industrial spaces. In vehicle applications containers or reservoirs may be provided for windscreen washing fluid, fuel, or diesel exhaust treatment fluid (AdBlue). In consumer applications, containers may be provided for appliances, such as refrigerators or coffee makers. In industrial applications, containers may include fermentation vessels, milk storage containers, technical fluid containers (e.g., oil or hydraulic fluid), process fluid containers, or the like. Some applications employ level sensing, some applications employ fluid characterization, and some applications employ both level detection and fluid characterization. In some applications, the container is not used for fluid storage, but rather as a chamber for fluid characterization of a fluid provided to an appliance or tool. Example fluid characterization parameters include, water hardness, ethanol concentration in wine, beer, or spirits, fat content in milk, or fluid contamination level for oil or hydraulic fluid. Knowledge about fluid composition is beneficial to prevent waste of consumables, to extend the lifespan of machinery, for control in industrial processes, to prevent clogging of heating elements by solid carbonates, to determine grime levels and detergent concentrations to control the consumption of detergent and water, to control a fermentation process, to determine the quality of technical fluids to ensure optimal fluid change intervals, or the like.

In some embodiments, a fluid characterization system measures charge transfer for a plurality of sensing intervals to generate a charge transfer curve. For a given test fluid, the charge transfer curve is unique for a given fluid characteristics, such as conductivity and permittivity. Thus, the charge transfer curve may be used for fluid characterization, for example to determine the hardness of water, to determine an ethanol concentration, to determine a contamination level, etc. In some embodiments, the test fluid is characterized using a neural network classifier that receives the conductivity curve as an input and generates a fluid characterization parameter as an output.

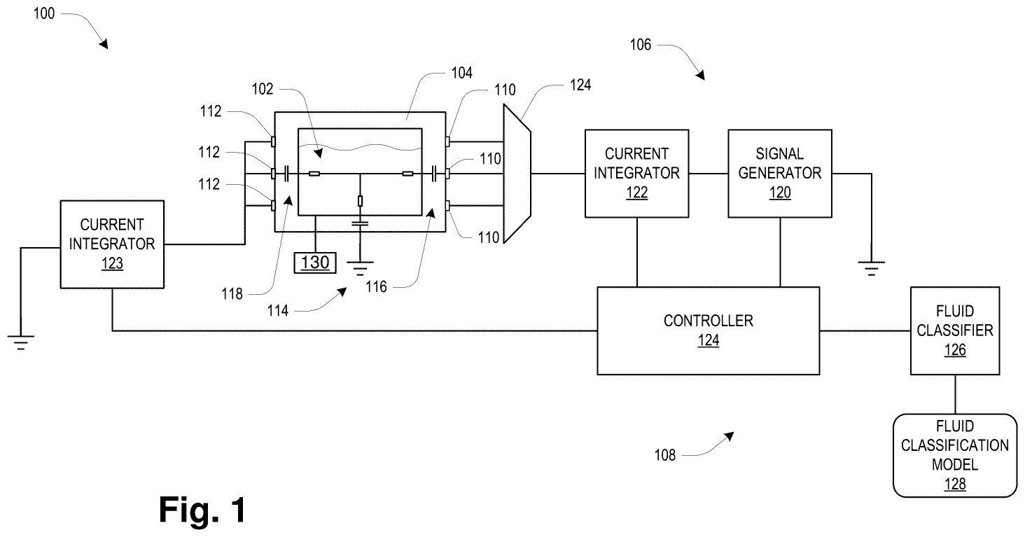

FIG. 1 is a block diagram of a fluid characterization system 100 for non-contact fluid sensing to characterize a test fluid 102 in a container 104, in accordance with some embodiments. Electrical characteristics of a test fluid 102 are represented by a distributed network of impedances. In some embodiments, the system 100 comprises analog processing blocks 106 and digital processing blocks 108. The analog processing blocks 106 are coupled to first electrodes 110 and second electrodes 112, where the first electrodes 110 are mounted at first points on an exterior surface of the container 104 that holds the test fluid 102 and the second electrodes 104 are mounted at second points on the exterior surface of the container 104, such as opposite the first points. In some embodiments, the first electrodes 110 and the second electrodes 112 are arranged in pairs at different heights on the container 104 to facilitate level detection. In some embodiments, the first electrodes 110 and the second electrodes 112 are arranged on the same side of the container 104 to simplify sensor mounting. The container 104 has an ambient ground 114 that represents the ambient grounding to surrounding objects and wall impedances 116, 118 that represent electrical characteristics of the container 104, each represented by a characteristic resistance and capacitance.

The analog processing blocks 106 define a single port network that is configured to couple a signal generator 120 and a current integrator 122 or one or more of the first electrodes 110 to determine a set of charge transfer measurements (e.g., a charge transfer curve 300) associated with the container 104 and the test fluid 102. The signal generator 120 generates an excitation signal, such as a rectangular signal, and the current integrator 122 integrates the current provided to one or more of the first electrodes 110 to determine charge transferred over a selected time interval.

The digital processing blocks 108 comprise a controller 124 that controls the signal generator 120 to generate the excitation signal and receives the current integration measurements from the current integrator 122 and a fluid classifier 126 that characterizes the test fluid 102 based on the charge transfer curve. In some embodiments, the fluid classifier 126 employs a fluid classification model 128 that receives the charge transfer curve as an input and generates one or more fluid characterization parameters as an output. In some embodiments, the fluid classification model 128 comprises a neural network model trained using reference charge transfer curves of fluids with known characteristics. The controller 124 iterates the excitation and current measurement over a set of different length time intervals to generate the charge transfer curve. In some embodiments, only the lower most first electrode 110 is used for charge transfer measurements for fluid characterization, while all of the first electrode 110 and second electrode 112 pairs are used for fluid level detection. In some embodiments, a charge transfer measurement is also used for level detection. In another embodiment, the first electrode 110 and second electrode 112 pairs that are covered by the test fluid 102 (i.e. the upper surface of the test fluid 102 is higher than the first electrode 110 and second electrode 112 pairs) are connected by routing circuitry 124 in parallel to increase the effective surface area available for sensing.

The current integrator 122 employs a self-capacitance measurement principle to determine charge transferred to the one or more first electrodes 110. In some embodiments, a second current integrator 123 is provided in series with the second electrodes to employ mutual-capacitance to determine charge transferred from the first electrodes 110 to the second electrodes 112. A first charge transfer curve may be generated based on data from the first integrator 122 and a second charge transfer curve may be generated based on data from the second integrator 123. The self-capacitance and mutual-capacitance charge transfer curves may be used for characterization of test fluid 102. The first charge transfer curve and the second charge transfer curve may be provided as inputs to the fluid classifier 126 and the fluid classification model 128.

In some embodiments, the fluid characterization system 100 comprises one or more sensors 130 that measure a fluid characteristic, such as density, or an environmental characteristic, such as temperature. The fluid classifier 126 may use information from the one or more sensors 130 for fluid characterization.

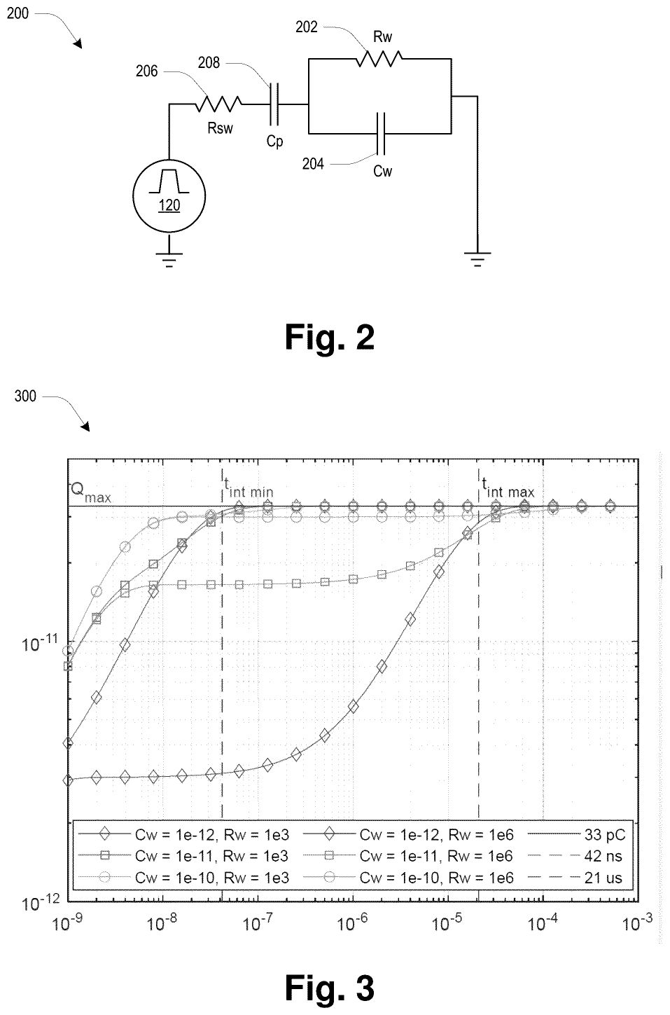

FIG. 2 is a diagram of an equivalent circuit 200 for the container 104 and the test fluid 102, in accordance with some embodiments. The effective resistance and capacitance of the test fluid 102 are represented by a resistor 202 (Rw) and a capacitor 204 (Cw). The wall capacitance is represented by a capacitor 206 (Cp), and the switch resistance is represented by a resistor 208 (Rsw). The signal generator 120 generates a rectangular excitation signal. The characteristics of the test fluid 102 affect the values of resistor 202 and the capacitor 204, which changes the response of the circuit 200 to the excitation signal.

FIG. 3 is a diagram of a set of charge transfer curves 300 for fluids 102 with different characteristics, in accordance with some embodiments. The charge transfer curves 300 are differentiated by fluid parameters, such as conductivity and/or permittivity that affect the values of Rw and Cw for a given wall capacitance, Cp, and switch resistance, Rsw. Note that the curves are distinguishable for different fluid parameters. Each data point of the charge transfer curve 300 represents the charge transferred through the electrodes 110, 112 as measured by the current integrator 122 (and, optionally, the current integrator 123) for a given time interval. In some embodiments, the time intervals are varied between a minimum time interval value, t_{int_min}, and a maximum time interval value, t_{int_max}. The maximum charge, Qₘₐₓ, is dependent on the wall capacitance, Cp.

In some embodiments, the fluid classifier 126 receives charge transfer data points from the controller 124 for the plurality of time intervals and accumulates the charge transfer data points to generate the charge transfer curve 300 for a test fluid 102 with unknown characteristics. The fluid classifier 126 employs the fluid classification model 128 to generate an output indicating a fluid parameter, such as conductivity, permittivity, ethanol concentration, diesel exhaust treatment fluid concentration, water hardness, a combination of output parameters, such as both conductivity and permittivity, or some other parameter or combination of parameters.

In some embodiments, the fluid classification model 128 is a neural network model trained using reference charge transfer curves from reference fluids with known parameter values, such as known conductivity and/or permittivity parameters. The fluid classification model 128 may also be trained using different ground states for the reference fluid or the container 104. For example, a reference charge transfer curve may be generated for a reference fluid with a known conductivity value or permittivity value for each of a set of ground states, such as ungrounded, weakly grounded, strongly grounded, fluid grounded, etc. The ground state affects the shape of the charge transfer curve. Training the fluid classification model 128 using different ground states allows the fluid classification model 128 to determine fluid parameters regardless of the grounding state. The training charge transfer curves for known fluids may be generated using theoretical calculations or by using the fluid characterization system 100 to generate a reference charge transfer curve for a fluid with known parameters. The training set may vary depending on the desired outputs. For example, if the desired output is only one parameter, the training set includes reference charge transfer curves with known values of the output parameter. If the desired output is more than one parameter, the training set includes reference charge transfer curves with known values for all of the output parameters or multiple sets of reference charge transfer curves, each set having known values of one of the output parameters.

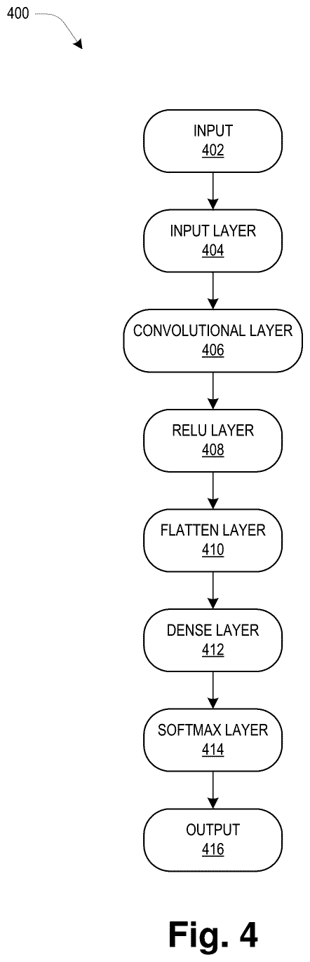

FIG. 4 is a diagram of a neural network classifier 400, in accordance with some embodiments. At 402, the neural network classifier 400 receives an input 402, such as a charge transfer curve. The neural network classifier 400 comprises an input layer 404, a convolutional layer 406, a rectified linear unit (ReLU) layer 408, a flatten layer 410, a dense layer 412, and a softmax layer 414 that generates an output 416 from the input 402. In some embodiments, the input layer 404 receives the data points of the charge transfer curve for the test fluid 102 as an input vector. In some embodiments, the convolutional layer 406 extracts features of the charge transfer curve applying a kernel and bias. In some embodiments, the convolutional layer 406 implements a Conv2D function with a kernel of 6×2×1×4 and a bias of 4, however other configurations may be used. In some embodiments, the ReLU layer 408 replaces negative numbers in the filtered data with zeroes. In some embodiments, the flatten layer 410 used to convert all the resultant 2-Dimensional arrays from the convolutional layer 406 into a continuous linear vector. In some embodiments, the dense layer 412 is a layer of neurons in which each neuron receives input from all the neurons of the previous layer and is used to classify the charge transfer curve based on output from the convolutional layer 406. In some embodiments, the softmax layer 414 is used as an activation function in the output layer that predicts a multinomial probability distribution. The output 416 represents one or more characterization parameters of the test fluid 102, such as conductivity, permittivity, ethanol concentration, diesel exhaust treatment fluid concentration, water hardness, a combination of output parameters, such as both conductivity and permittivity, or some other parameter or combination of parameters.

In some embodiments, the fluid classification model 128 is trained for a particular application, such as determining ethanol concentration. Conductivity and permittivity of an ethanol-water mixture is known to be dependent on the weight percentage of ethanol. After the fluid classification model 128 is trained using charge transfer curves from fluids with different ethanol concentrations and ground states, the fluid characterization system 100 may be employed to sense the ethanol concentration of the test fluid 102 and output the percentage of ethanol. The ethanol percentage may be used to automatically control a fermentation system or to automatically generate messages when ethanol percentage thresholds are met.

Similarly, the fluid classification model 128 may be trained to detect water hardness for use by appliances, such as coffee machines, washing machines, dishwashers, wet vacuum cleaners, water softeners, or some other appliance. The appliance may have an internal water softener or may use settings that depend on water hardness. The fluid characterization system 100 may be integrated into the appliance, such that the appliance can enable or disable an internal water softener or select a setting based on water hardness measured by the fluid characterization system 100. For example, if the fluid characterization system 100 detects that the incoming water is adequately soft (an in-house water softener is in place that provided soft water to the appliance), the appliance can disable the internal water softener. If the appliance uses a water softener, a recharge may be initiated responsive to the fluid characterization system 100 detecting a water hardness exceeding a threshold. Initiating the recharge based on measured water hardness reduces waste from unnecessary recharges.

In another embodiment, the fluid classification model 128 may be trained to identify an unknown fluid. In additional to the charge transfer curve an additional fluid characteristic, such as density may be provided as an input to the fluid classification model 128. After the fluid classification model 128 is trained using charge transfer curves from fluids with different densities, the fluid characterization system 100 may be employed to identify unknown fluids using a measured charge transfer curve and density information from the sensor.

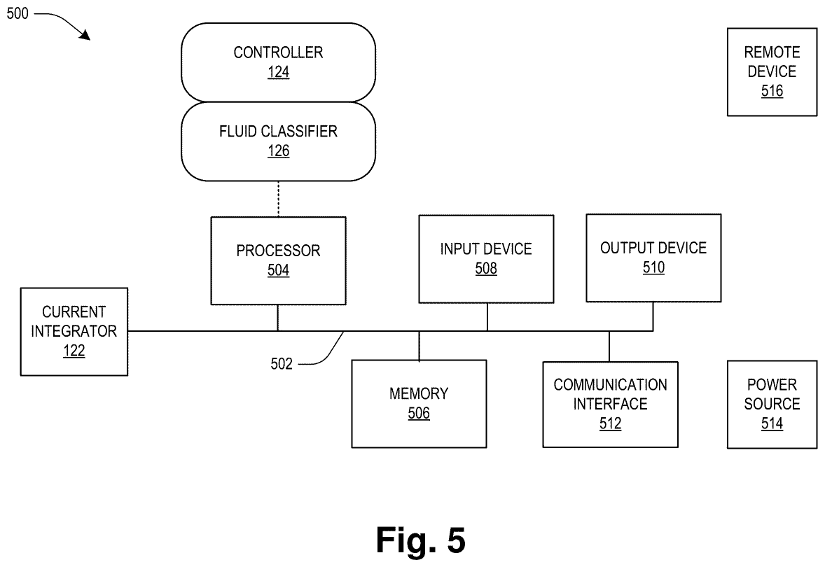

FIG. 5 is a diagram of a device 500 for implementing the fluid characterization system 100, in accordance with some embodiments. In some embodiments, the device 500 comprises a bus 502, a processor 504, a memory 506 that stores software instructions or operations, an input device 508, an output device 510, a communication interface 512, and a power source 514, such as a battery. The processor 504 receives data from the current integrator 122 (and, optionally, the current integrator 123) and implements a software application that implements the controller 124 and the fluid classifier 126. The device 500 may include fewer components, additional components, different components, and/or a different arrangement of components than those illustrated in FIG. 5.

According to some embodiments, the bus 502 includes a path that permits communication among the components of the device 500. For example, the bus 502 may include a system bus, an address bus, a data bus, and/or a control bus. The bus 502 may also include bus drivers, bus arbiters, bus interfaces, clocks, and so forth. The processor 504 includes one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. The processor 504 may be implemented as hardware (e.g., a microprocessor, etc.), a combination of hardware and software (e.g., a SoC, an ASIC, etc.), may include one or multiple memories (e.g., cache, etc.), etc.

In some embodiments, the processor 504 controls the overall operation or a portion of the operation(s) performed by the controller 124 and the fluid classifier 126. The processor 504 performs one or multiple operations based on an operating system and/or various applications or computer programs (e.g., software). The processor 504 accesses instructions from the memory 506, from other components of the device 500, and/or from a source external to the device 500 (e.g., a network, another device, etc.). The processor 504 may perform an operation and/or a process based on various techniques including, for example, multithreading, parallel processing, pipelining, interleaving, etc.

In some embodiments, the memory 506 includes one or multiple memories and/or one or multiple other types of storage mediums. For example, the memory 506 may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory, and/or some other suitable type of memory. The memory 506 may include a hard disk, a magnetic disk, an optical disk, a magneto-optic disk, a solid state disk, a Micro-Electromechanical System (MEMS)-based storage medium, a nanotechnology-based storage medium, and/or some other suitable disk. The memory 506 may include drives for reading from and writing to the storage medium. The memory 506 may be external to and/or removable from the device 500, such as, for example, a Universal Serial Bus (USB) memory stick, a dongle, a hard disk, mass storage, off-line storage, or some other type of storing medium (e.g., a compact disk (CD), a digital versatile disk (DVD), a Blu-Ray disk (BD), etc.). The memory 506 may store data, software, and/or instructions related to the operation of the activity classifier 100.

The communication interface 512 permits the device 500 to communicate with other devices, networks, systems, sensors, and/or the like on a network. The communication interface 512 may include one or multiple wireless interfaces and/or wired interfaces. For example, the communication interface 512 may include one or multiple transmitters and receivers, or transceivers. The communication interface 512 may operate according to a protocol stack and a communication standard. In some embodiments, the communication interface 512 includes an antenna. The communication interface 512 may include various processing logic or circuitry (e.g., multiplexing/de-multiplexing, filtering, amplifying, converting, error correction, etc.). In some embodiments, the communication interface 512 operates using a long range wireless protocol, such as a cellular protocol or a WiFi protocol, a short range protocol, such as BLUETOOTH™, or a wired protocol, such as Ethernet.

In some embodiments, the input device 508 permits an input into the device 500. For example, the input device 508 may comprise a keyboard, a mouse, a display, a touchscreen, a touchless screen, a button, a switch, an input port, speech recognition logic, and/or some other type of suitable visual, auditory, or tactile input component. The output device 510 permits an output from the device 500. For example, the output device 510 may include a speaker, a display, a touchscreen, a touchless screen, a projected display, a light, an output port, and/or some other type of suitable visual, auditory, or tactile output component. In some embodiments, the output device 518 may be remote and may communicate with the processor 504 using the communication interface 512.

In some embodiments, the fluid characterization parameter generated by the fluid characterization system 100 is used to change an operating parameter of a remote device 516, such as based on communication over the communication interface 512. For example, if the remote device 516 is an appliance, the operating parameter may be a mode of the remote device 516, such as water softener enabled mode or a water softener disabled mode, or some other mode. In some embodiments, the remote device 516 may take an action based on the fluid characterization parameter, such as initiating a charge cycle of a water softener. In some embodiments, the remote device 516 may display an alert or notification based on the fluid characterization parameter, such as an alert to terminate fermentation, an alert of a fluid parameter being outside accepted limits, or some other alert.

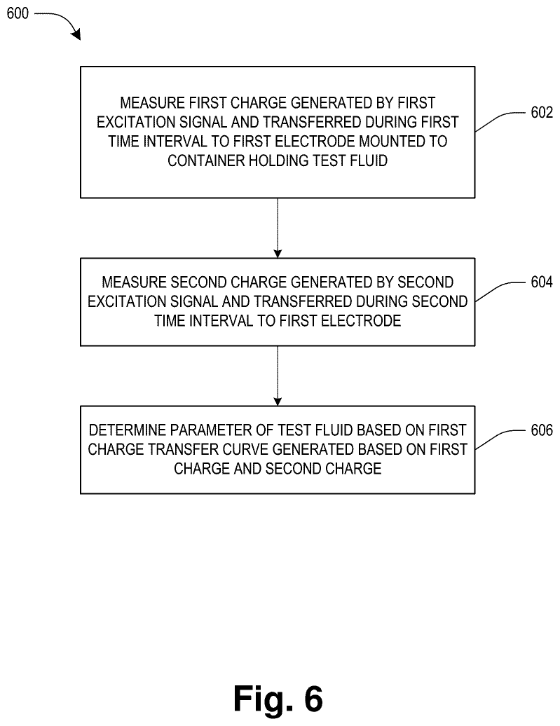

FIG. 6 is a flow chart illustrating an example method 600 for fluid characterization. At 602, a first charge generated by a first excitation signal and transferred during a first time interval to a first electrode 110 mounted to a container 104 holding a test fluid 102 is measured. At 604, a second charge generated by a second excitation signal and transferred during a second time interval to the first electrode 110 is measured. At 606, a parameter of the test fluid is determined based on a charge transfer curve generated based on the first charge and the second charge.

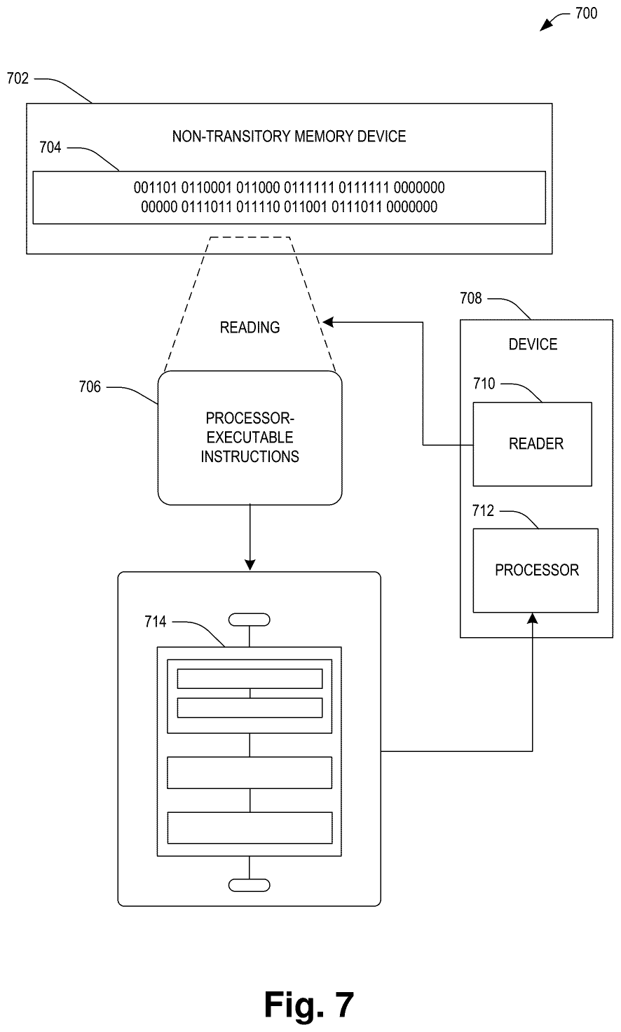

FIG. 7 illustrates an exemplary embodiment 700 of a computer-readable medium 702, in accordance with some embodiments. One or more embodiments involve a computer-readable medium comprising processor-executable instructions configured to implement one or more of the techniques presented herein. The embodiment 700 comprises a non-transitory computer-readable medium 702 (e.g., a CD-R, DVD-R, flash drive, a platter of a hard disk drive, etc.), on which is encoded computer-readable data 704. This computer-readable data 704 in turn comprises a set of processor-executable computer instructions 706 that, when executed by a computing device 708 including a reader 710 for reading the processor-executable computer instructions 706 and a processor 712 for executing the processor-executable computer instructions 706, are configured to facilitate operations according to one or more of the principles set forth herein. In some embodiments, the processor-executable computer instructions 706, when executed, are configured to facilitate performance of a method 714, such as at least some of the aforementioned method(s). In some embodiments, the processor-executable computer instructions 706, when executed, are configured to facilitate implementation of a system, such as at least some of the one or more aforementioned system(s). Many such computer-readable media may be devised by those of ordinary skill in the art that are configured to operate in accordance with the techniques presented herein.

In an embodiment of the techniques presented herein, a method comprises measuring a first charge generated by a first excitation signal and transferred during a first time interval to a first electrode mounted to a container holding a test fluid, measuring a second charge generated by a second excitation signal and transferred during a second time interval to the first electrode, and determining a parameter of the test fluid based on a first charge transfer curve generated based on the first charge and the second charge.

In an embodiment of the techniques presented herein, determining the parameter of the test fluid comprises determining the parameter using a fluid classification model based on the first charge transfer curve.

In an embodiment of the techniques presented herein, the fluid classification model comprises a neural network model, and the method comprises training the neural network model using a first reference charge transfer curve for a reference fluid with a first ground state and a second reference charge transfer curve for the reference fluid with a second ground state different than the first ground state.

In an embodiment of the techniques presented herein, the fluid classification model comprises a neural network model, and the method comprises training the neural network model using a first reference charge transfer curve associated with a first reference fluid having a first known characteristic and a second reference charge transfer curve associated with a second reference fluid having a second known characteristic different than the first known characteristic.

In an embodiment of the techniques presented herein, the method comprises placing the first reference fluid in the container, generating the first reference charge transfer curve by measuring a third charge generated by a third excitation signal and transferred during a third time interval to the first electrode, measuring a fourth charge generated by a fourth excitation signal and transferred during a fourth time interval to the first electrode, and generating the first reference charge transfer curve based on the third charge and the fourth charge.

In an embodiment of the techniques presented herein, measuring the first charge comprises integrating a current provided to the first electrode during the first time interval.

In an embodiment of the techniques presented herein, the method comprises measuring a third charge generated by the first excitation signal and transferred during the first time interval to a second electrode mounted to the container, measuring a fourth charge generated by the second excitation signal and transferred during the second time interval to the second electrode, and generating a second charge transfer curve based on the third charge and the fourth charge, wherein determining the parameter of the test fluid based on the first charge transfer curve comprises determining the parameter of the test fluid based on the first charge transfer curve and the second charge transfer curve.

In an embodiment of the techniques presented herein, determining the parameter of the test fluid comprises determining at least one of conductivity, permittivity, ethanol concentration, diesel exhaust treatment fluid concentration, or water hardness.

In an embodiment of the techniques presented herein, the method comprises controlling a device based on the parameter of the test fluid.

In an embodiment of the techniques presented herein, the method comprises determining that an upper surface of the test fluid in the container is at a higher elevation than a second electrode mounted to the container, and connecting the first electrode in series with the second electrode.

In an embodiment of the techniques presented herein, a system comprises a container, a first electrode mounted to the container, a signal generator configured to apply a first excitation signal to the first electrode during a first time interval and to apply a second excitation signal to the first electrode during a second time interval, a first device configured to measure a first charge generated by the first excitation signal and transferred during the first time interval to the first electrode and to measure a second charge generated by the second excitation signal and transferred during the second time interval to the first electrode, and a processor configured to determine a parameter of a test fluid in the container based on a first charge transfer curve generated based on the first charge and the second charge.

In an embodiment of the techniques presented herein, the processor is configured to determine the parameter using a fluid classification model based on the first charge transfer curve.

In an embodiment of the techniques presented herein, the fluid classification model comprises a neural network model.

In an embodiment of the techniques presented herein, the first device comprises a current integrator.

In an embodiment of the techniques presented herein, the system comprises a second electrode mounted to the container, wherein the first device is configured to measure a third charge generated by the first excitation signal and transferred during the first time interval to a second electrode mounted to the container, measure a fourth charge generated by the second excitation signal and transferred during the second time interval to the second electrode, and generate a second charge transfer curve based on the third charge and the fourth charge, and the processor is configured to determine the parameter of the test fluid in the container based on the first charge transfer curve and the second charge transfer curve.

In an embodiment of the techniques presented herein, the parameter of the test fluid comprises at least one of conductivity, permittivity, ethanol concentration, diesel exhaust treatment fluid concentration, or water hardness.

In an embodiment of the techniques presented herein, the processor is configured to control a second device based on the parameter of the test fluid.

In an embodiment of the techniques presented herein, a non-transitory computer-readable medium stores instructions that when executed facilitate performance of operations comprising receiving a first charge generated by a first excitation signal and transferred during a first time interval to a first electrode mounted to a container holding a test fluid, receiving a second charge generated by a second excitation signal and transferred during a second time interval to the first electrode, and determining a parameter of the test fluid based on a charge transfer curve generated based on the first charge and the second charge.

In an embodiment of the techniques presented herein, the

operations comprise determining the parameter of the test fluid using a fluid classification model based on the charge transfer curve.

In an embodiment of the techniques presented herein, determining the parameter of the test fluid comprises determining at least one of conductivity, permittivity, ethanol concentration, diesel exhaust treatment fluid concentration, or water hardness.

The term “computer readable media” may include communication

media. Communication media typically embodies computer readable instructions or other data in a “modulated data signal” such as a carrier wafer or other transport mechanism and includes any information delivery media. The term “modulated data signal” may include a signal that has one or more of its characteristics set or changed in such a manner as to encode information in the signal.

Any aspect or design described herein as an “example” and/or the like is not necessarily to be construed as advantageous over other aspects or designs. Rather, use of the word “example” is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method comprising:
measuring a first charge generated by a first excitation signal and transferred during a first time interval to a first electrode mounted to a container holding a test fluid;
measuring a second charge generated by a second excitation signal and transferred during a second time interval to the first electrode; and
determining a parameter of the test fluid based on a first charge transfer curve generated based on the first charge and the second charge.

2. The method of claim 1, wherein:
determining the parameter of the test fluid comprises determining the parameter using a fluid classification model based on the first charge transfer curve.

3. The method of claim 2, wherein:
the fluid classification model comprises a neural network model, and
the method comprises training the neural network model using a first reference charge transfer curve for a reference fluid with a first ground state and a second reference charge transfer curve for the reference fluid with a second ground state different than the first ground state.

4. The method of claim 2, wherein:
the fluid classification model comprises a neural network model, and
the method comprises training the neural network model using a first reference charge transfer curve associated with a first reference fluid having a first known characteristic and a second reference charge transfer curve associated with a second reference fluid having a second known characteristic different than the first known characteristic.

5. The method of claim 4, comprising:
placing the first reference fluid in the container;
generating the first reference charge transfer curve by:
measuring a third charge generated by a third excitation signal and transferred during a third time interval to the first electrode;
measuring a fourth charge generated by a fourth excitation signal and transferred during a fourth time interval to the first electrode; and
generating the first reference charge transfer curve based on the third charge and the fourth charge.

6. The method of claim 1, wherein:
measuring the first charge comprises integrating a current provided to the first electrode during the first time interval.

7. The method of claim 1, comprising:
measuring a third charge generated by the first excitation signal and transferred during the first time interval to a second electrode mounted to the container;
measuring a fourth charge generated by the second excitation signal and transferred during the second time interval to the second electrode; and
generating a second charge transfer curve based on the third charge and the fourth charge, wherein:
determining the parameter of the test fluid based on the first charge transfer curve comprises determining the parameter of the test fluid based on the first charge transfer curve and the second charge transfer curve.

8. The method of claim 1, wherein:
determining the parameter of the test fluid comprises determining at least one of conductivity, permittivity, ethanol concentration, diesel exhaust treatment fluid concentration, or water hardness.

9. The method of claim 1, comprising:
controlling a device based on the parameter of the test fluid.

10. The method of claim 1, comprising:
determining that an upper surface of the test fluid in the container is at a higher elevation than a second electrode mounted to the container; and
connecting the first electrode in series with the second electrode.

11. A system, comprising:
a container;
a first electrode mounted to the container;
a signal generator configured to apply a first excitation signal to the first electrode during a first time interval and to apply a second excitation signal to the first electrode during a second time interval;
a first device configured to measure a first charge generated by the first excitation signal and transferred during the first time interval to the first electrode and to measure a second charge generated by the second excitation signal and transferred during the second time interval to the first electrode; and
a processor configured to determine a parameter of a test fluid in the container based on a first charge transfer curve generated based on the first charge and the second charge.

12. The system of claim 11, wherein:
the processor is configured to determine the parameter using a fluid classification model based on the first charge transfer curve.

13. The system of claim 12, wherein:
the fluid classification model comprises a neural network model.

14. The system of claim 11, wherein:
the first device comprises a current integrator.

15. The system of claim 11, comprising:
a second electrode mounted to the container, wherein:
the first device is configured to measure a third charge generated by the first excitation signal and transferred during the first time interval to a second electrode mounted to the container, measure a fourth charge generated by the second excitation signal and transferred during the second time interval to the second electrode, and generate a second charge transfer curve based on the third charge and the fourth charge, and
the processor is configured to determine the parameter of the test fluid in the container based on the first charge transfer curve and the second charge transfer curve.

16. The system of claim 11, wherein:
the parameter of the test fluid comprises at least one of conductivity, permittivity, ethanol concentration, diesel exhaust treatment fluid concentration, or water hardness.

17. The system of claim 11, wherein:
the processor is configured to control a second device based on the parameter of the test fluid.

18. A non-transitory computer-readable medium storing instructions that when executed facilitate performance of operations comprising:
receiving a first charge generated by a first excitation signal and transferred during a first time interval to a first electrode mounted to a container holding a test fluid;
receiving a second charge generated by a second excitation signal and transferred during a second time interval to the first electrode; and
determining a parameter of the test fluid based on a charge transfer curve generated based on the first charge and the second charge.

19. The non-transitory computer-readable medium of claim 18, wherein the operations comprise:
determining the parameter of the test fluid using a fluid classification model based on the charge transfer curve.

20. The non-transitory computer-readable medium of claim 18, wherein determining the parameter of the test fluid comprises:
determining at least one of conductivity, permittivity, ethanol concentration, diesel exhaust treatment fluid concentration, or water hardness.
